(19) United States
(12) Patent Application Publication
(10) Pub. No.: US 2012/0262512 A1
(43) Pub. Date: Oct. 18, 2012

(54) PIEZOELECTRIC ELEMENT DRIVE CIRCUIT AND FLUID EJECTION DEVICE

(75) Inventors: Atsushi OSHIMA, Shiojiri-shi (JP); Kunio TABATA, Shiojiri-shi (JP); Shinichi MIYAZAKI, Suwa-shi (JP); Noritaka IDE, Shiojiri-shi (JP); Hiroyuki YOSHINO, Suwa-shi (JP)

(73) Assignee: SEIKO EPSON CORPORATION, TOKYO (JP)

(21) Appl. No.: 13/448,160

(22) Filed: Apr. 16, 2012

(30) Foreign Application Priority Data
Apr. 18, 2011 (JP) 2011-091798

(51) Int. Cl. B41J 29/38

(52) U.S. Cl. 347/10

(57) ABSTRACT

A reference voltage waveform reciprocating between a first voltage and a second voltage is supplied to a piezoelectric element via a switch. If a switch is set to a connected state (ON), the reference voltage waveform is applied to the piezoelectric element, and if the switch is set to a disconnected state (OFF), the voltage when the switch is set to OFF continues to be applied. Therefore, it becomes possible to apply a variety of drive signals only by switching the switch in accordance with increase and decrease of the reference voltage waveform, and there is no need to store a plurality of types of drive signals. Further, it is possible to start to apply the drive signal immediately when the voltage of the reference voltage waveform reaches the target voltage.

### BACKGROUND

1. Technical Field

The present invention relates to a technology for applying a drive signal to thereby drive a piezoelectric element.

2. Related Art

There has been known a fluid ejection device, such as an inkjet printer, for applying a drive signal to a piezoelectric element as a capacitive load to thereby eject a fluid such as ink. The fluid ejection device is equipped with a drive circuit, and applies the drive signal generated by the drive circuit to thereby drive the piezoelectric element. Further, since the piezoelectric element extends or contracts in accordance with the voltage applied thereto, by switching the drive signal to be applied to the piezoelectric element, the ejection conditions (e.g., an ejection amount) of the fluid can be switched.

Therefore, there is proposed a technology of repeatedly outputting a plurality of types of drive signals (e.g., drive signals A, B, and C) in series and then switching the drive signal to be selected on the piezoelectric element side to thereby switch the ejection amount of the fluid (JP-A-10-81014).

However, according to the technology thus proposed, since the plurality of types of drive signals needs to be stored previously, there is a problem that a large storage capacity is required on the drive circuit side. Further, since the plurality of types of drive signals is output in series from the drive circuit, in the case of selecting a certain type of drive signal (e.g., the drive signal A), it is not achievable to select the target drive signal (the drive signal A) during the period in which other types of drive signals (e.g., the drive signals B, C) are output. Therefore, there is another problem that it is difficult to increase (to raise the drive frequency of the piezoelectric element) the number of times of driving of the piezoelectric element per hour.

### SUMMARY

An advantage of some aspects of the invention is to provide a technology capable of outputting a plurality of types of drive signals without providing a large storage capacity, and moreover raising the drive frequency of the piezoelectric element.

An aspect of the invention is directed to a piezoelectric element drive circuit used for a fluid ejection device adapted to deform a fluid chamber using a piezoelectric element to thereby eject a fluid in the fluid chamber, and adapted to apply a drive signal to the piezoelectric element, including a reference voltage waveform generator adapted to generate a reference voltage waveform, which has a voltage increasing from a first voltage to a second voltage higher than the first voltage, and then decreasing from the second voltage to the first voltage, at a predetermined repetition period, a switch disposed between the reference voltage waveform generator and the piezoelectric element, and adapted to switch between a connected state in which the reference voltage waveform generator and the piezoelectric element are electrically connected to each other and a disconnected state in which the reference voltage waveform generator and the piezoelectric element are electrically disconnected from each other, and a switch control section adapted to switch the switch between the connected state and the disconnected state in accordance with increase and decrease of the voltage of the reference voltage waveform to thereby apply a drive signal to the piezoelectric element.

In the piezoelectric element drive circuit according to this aspect of the invention having such a configuration, the switch is disposed between the reference voltage waveform generator and the piezoelectric element, and the voltage of the reference voltage waveform is applied to the piezoelectric element during the period in which the switch is set to the connected state. Further, since the piezoelectric element is a so-called capacitive electrical load (a capacitive load), during the period in which the switch is set to the disconnected state, the state in which the voltage having been applied when the switch is set to the disconnected state is applied without change is maintained. Further, since the voltage waveform reciprocating between the first voltage with a predetermined level and the second voltage with a predetermined level many times is output from the reference voltage waveform generator, by repeating the process of setting the switch to the connected state when the voltage of the reference voltage waveform reaches a desired voltage, then setting the switch to the disconnected state when the voltage of the reference voltage waveform reaches the next desired voltage, an appropriate drive signal can be applied to the piezoelectric element.

Further, by applying the drive signal in such a manner, various types of drive signals can be applied by repeatedly outputting the same reference voltage waveform and just simply making the timings different from each other at which the switch is set to the connected state or the disconnected state. Therefore, even in the case of applying a plurality of types of drive signals to the piezoelectric element, it is not required to previously store the plurality of types of drive signals. As a result, it becomes possible to apply a number of drive signals different from each other without increasing the storage capacity of the piezoelectric element drive circuit.

In addition, since the reference voltage waveform is output at a predetermined repetition period, and when the voltage of the reference voltage waveform reaches the desired voltage, application of the drive signal to the piezoelectric element can immediately be started. In other words, there is no need to wait to drive the piezoelectric element until the target drive signal to be applied to the piezoelectric element is supplied as in the related art. Therefore, it is also possible to raise the drive frequency of the piezoelectric element.

Further, in the piezoelectric element drive circuit according to this aspect of the invention described above, the following is also possible. Firstly, the fluid ejection device is provided with a plurality of piezoelectric elements, and the switch is disposed to each of the piezoelectric elements. Further, it is also possible to arrange that each of the switches is individually switched between the connected state and the disconnected state.

According to this configuration, it becomes possible to apply a certain drive signal to a certain piezoelectric element while applying another drive signal to another piezoelectric element. Further, since the drive signal to be applied to the piezoelectric element can finely be adjusted by the timings of switching the switch between the connected state and the disconnected state, even in the case in which a variation exists in the plurality of piezoelectric elements or in the fluid chambers, it becomes possible to eject the fluid in the condition in which the variation is corrected.

Further, in the piezoelectric element drive circuit according to this aspect of the invention described above, it is also possible to arrange that the reference voltage waveform is generated at the repetition period equal to or shorter than a half of the characteristic vibration period of the fluid chamber.

In the fluid chamber after deforming the fluid chamber to thereby eject the fluid in the fluid chamber, there occurs a pressure fluctuation (and the flow of the fluid in conjunction therewith) in which the pressure of the fluid varies at a period corresponding to the characteristic vibration period of the fluid chamber. If the drive signal is applied to the piezoelectric element in the state in which such a pressure fluctuation (the flow of the fluid) remains, the pressure variation of the fluid chamber due to the expansion or contraction of the piezoelectric element is disturbed by the pressure fluctuation, and it becomes unachievable to eject the fluid normally. Therefore, it is desirable to promptly attenuate the pressure fluctuation caused in the fluid chamber after ejection of the fluid. In this regard, it is preferable to set the repetition period of the reference voltage waveform to be equal to or shorter than a half of the characteristic vibration period of the fluid chamber because it becomes possible to promptly attenuate the pressure fluctuation by restoring the capacity of the fluid chamber to the original capacity at the timing with which the pressure fluctuation caused in the fluid chamber is canceled after reducing the capacity of the fluid chamber for ejecting the fluid. Here, the “characteristic vibration period” denotes a period of a characteristic vibration determined by the physical characteristics inherent in an object (the fluid chamber in this aspect of the invention).

Further, the piezoelectric element drive circuit according to this aspect of the invention described above can be used as a circuit for applying the drive signal to the piezoelectric element with respect to the fluid ejection device for ejecting the fluid from the ejection nozzle by applying the drive signal to the piezoelectric element.

As described above, the piezoelectric element drive circuit according to this aspect of the invention is capable of applying a number of types of drive signals to the piezoelectric element even if a large storage capacity is not installed. Therefore, it becomes possible to easily realize the fluid ejection device capable of ejecting the fluid in a plurality of manners.

### BRIEF DESCRIPTION OF THE DRAWINGS

The invention will be described with reference to the accompanying drawings, wherein like numbers reference like elements.

FIG. 1 is an explanatory diagram exemplifying an inkjet printer equipped with a piezoelectric element drive circuit according to an embodiment of the invention.

FIG. 2 is an explanatory diagram showing an internal structure of an ejection head of the inkjet printer in detail.

FIG. 3 is an explanatory diagram exemplifying a drive signal to be applied to a piezoelectric element.

FIG. 4 is an explanatory diagram showing a circuit configuration of the piezoelectric element drive circuit according to the present embodiment.

FIG. 5 is an explanatory diagram exemplifying a reference voltage waveform to be output from a reference voltage waveform generator.

FIG. 6 is an explanatory diagram exemplifying how the drive signal is applied to the piezoelectric element by switching between ON/OFF of a gate element.

FIGS. 7A and 7B are explanatory diagrams exemplifying how the drive signal is changed by changing the timing of switching ON/OFF the gate element.

FIG. 8 is an explanatory diagram exemplifying the drive signal to be applied to the piezoelectric element in a first modified example.

FIG. 9 is an explanatory diagram exemplifying how the timing of ejecting ink is shifted in a second modified example.

FIGS. 10A and 10B are explanatory diagrams exemplifying a variety of reference voltage waveforms as a third modified example.

FIGS. 11A and 11B are explanatory diagrams regarding a relationship between a characteristic vibration period inherent in an ink chamber and a repetition period Tp of the reference voltage waveform.

FIGS. 12A and 12B are explanatory diagrams regarding the relationship between the characteristic vibration period inherent in the ink chamber and the repetition period Tp of the reference voltage waveform.

FIG. 13 is an explanatory diagram exemplifying a fluid ejection device for ejecting a liquid using the piezoelectric element.

### DESCRIPTION OF AN EXEMPLARY EMBODIMENT

Hereinafter, an embodiment of the invention will be explained along the following procedures to thereby clarify the content of the invention described above.

A. Device Configuration

B. Configuration of Piezoelectric Element Drive Circuit

C. Method of Applying Drive Signal

D. Modified Examples

D-1. First Modified Example

D-2. Second Modified Example

D-3. Third Modified Example

D-4. Fourth Modified Example

D-5. Fifth Modified Example

### A. Device Configuration

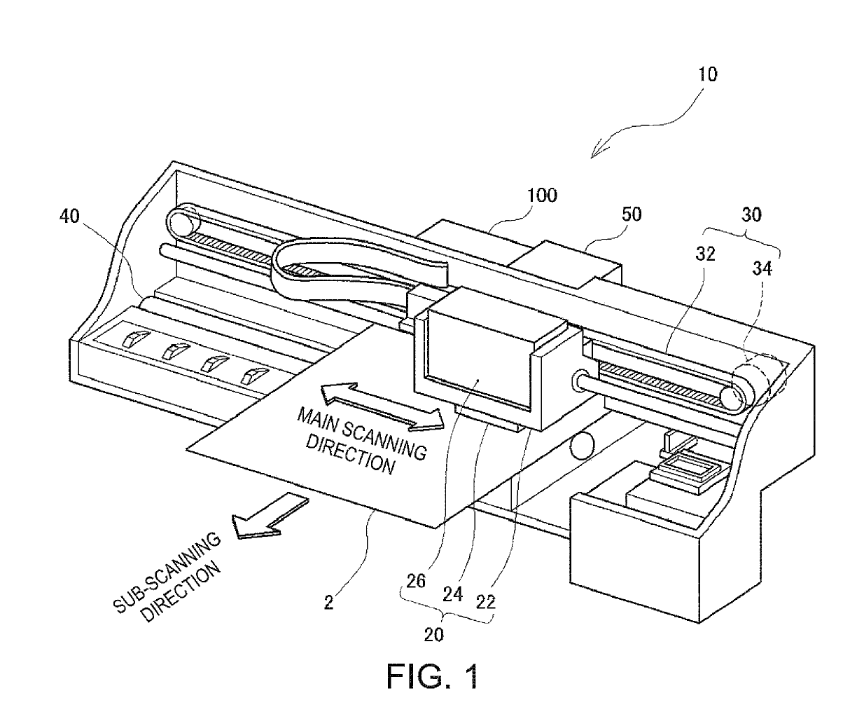

FIG. 1 is an explanatory diagram exemplifying an inkjet printer 10 equipped with a piezoelectric element drive circuit 100 according to the present embodiment. The inkjet printer 10 shown in the drawing performs printing of an image by ejecting ink on a print medium 2 while reciprocating a carriage 20 above the print medium 2. Therefore, the inkjet printer 10 according to the present embodiment corresponds to an aspect of the fluid ejection device according to the invention. The inkjet printer 10 is also equipped with a drive mechanism 30 for reciprocating the carriage 20, a platen roller 40 for performing paper feeding of the print medium 2, and so on. The carriage 20 is provided with an ink cartridge 26 housing the ink, a carriage case 22 attached with the ink cartridge 26, an ejection head 24 mounted on a bottom surface side (the side facing to the print medium 2) of the carriage case 22 and for ejecting the ink, and so on. It should be noted that a piezoelectric element is used as an actuator of the ejection head 24. Further, the direction in which the carriage 20 reciprocates is referred to as a main scanning direction, and the direction in which the paper feed is performed on the print medium 2 is referred to as a sub-scanning direction.

The drive mechanism 30 for reciprocating the carriage 20 in the main scanning direction is composed of a timing belt 32 stretched between pulleys, a stepping motor 34 for driving the timing belt 32 via the pulleys, and so on. A part of the timing belt 32 is fixed to the carriage case 22, and by driving the timing belt 32, the carriage case 22 can be reciprocated. Further, the platen roller 40 constitutes a paper feed mechanism for performing the paper feed of the print medium 2 together with a drive motor and a gear mechanism not shown, and is capable of performing the paper feed on the print medium 2 in the sub-scanning direction by a predetermined amount.

The inkjet printer 10 is also equipped with a printer control circuit 50 for controlling the overall operation, and a piezoelectric element drive circuit 100 for driving the piezoelectric element inside the ejection head 24. The printer control circuit 50 controls operations of the piezoelectric element drive circuit 100, the drive mechanism 30, the paper feed mechanism, and so on.

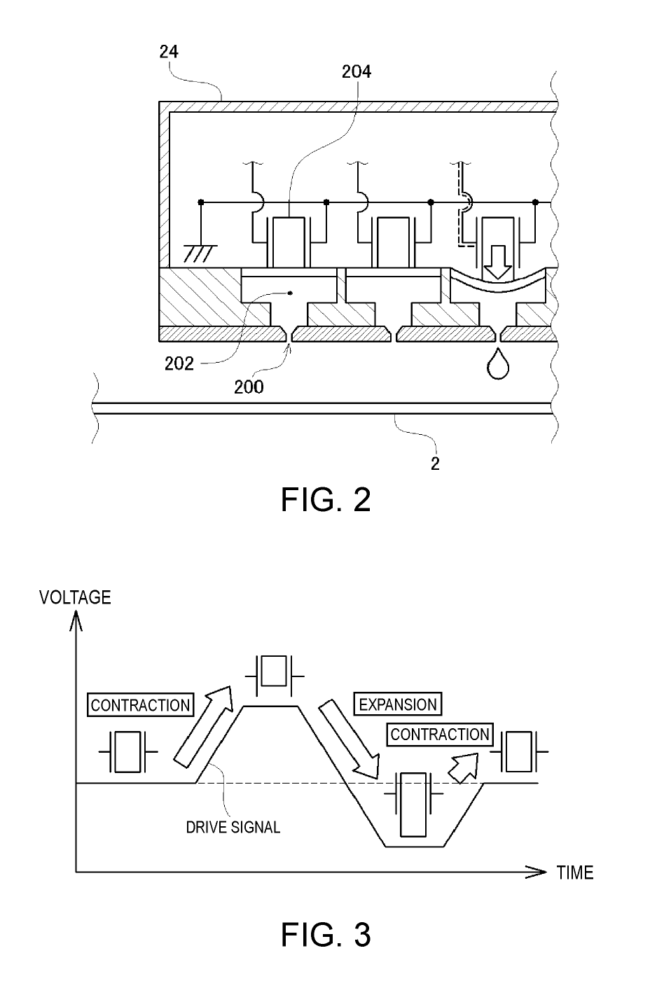

FIG. 2 is an explanatory diagram showing an internal mechanism of the ejection head 24 in detail. As shown in the drawing, a bottom surface (a surface facing to the print medium 2) of the ejection head 24 is provided with a plurality of ejection nozzles 200 for ejecting the ink. The ejection nozzles 200 are connected to respective ink chambers 202, and the ink chambers 202 are filled with the ink supplied from the ink cartridge 26. A piezoelectric element 204 is disposed on each of the ink chambers 202, and when a drive signal is applied to the piezoelectric element 204, the piezoelectric element 204 is deformed. It is arranged that the ink in the ink chamber 202 can be ejected from the ejection nozzle 200 as a result. Further, by changing the drive signal to be applied to the piezoelectric element 204, it is also possible to change the state (e.g., an ejection amount) of the ink ejection.

FIG. 3 is an explanatory diagram exemplifying the drive signal to be applied to the piezoelectric element 204. As shown in the drawing, the drive signal has a voltage waveform formed by combining trapezoidal shapes in which the voltage rises with time, and then drops to be restored to the original voltage. Further, the drawing shows how the piezoelectric element 204 contracts in accordance with the drive signal. The piezoelectric element 204 contracts when the voltage of the drive signal rises, and expands when the voltage drops. Therefore, when raising the voltage of the drive signal, the ink chamber 202 expands while being pulled by the piezoelectric element 204, and thus the ink is supplied to the inside of the ink chamber 202 from the ink cartridge 26. Subsequently, when dropping the voltage of the drive signal, the piezoelectric element 204 extends to compress the ink chamber 202, and as a result, the ink is ejected from the ejection nozzle 200. Further, if the amount of rise in the voltage of the drive signal is limited, sufficient amount of ink is not supplied to the ink chamber 202, and therefore, the amount of the ink ejected when dropping the voltage of the drive signal can be reduced. Alternatively, in the case in which the amount of rise in the voltage of the drive signal is not limited, and therefore, sufficient amount of ink is supplied to the ink chamber 202, the amount of ejection of the ink can be reduced by suppressing the amount of drop of the voltage of the drive signal. As described above, by changing the drive signal to be applied to the piezoelectric element 204, the amount of ejection of the ink can be changed.

However, if the number of types of the drive signal increases, a large storage capacity becomes necessary for storing all of the types of the drive signal. Further, since the characteristics of the respective ejection nozzles 200 ejecting the ink are different between the ejection nozzles 200, if it is attempted to correct the variation in the characteristics using the drive signal, it becomes necessary to store a huge number of types of drive signals. Therefore, in the piezoelectric element drive circuit 100 according to the present embodiment, the drive signal is applied to the piezoelectric element 204 using the following method.

### B. Configuration of Piezoelectric Element Drive Circuit

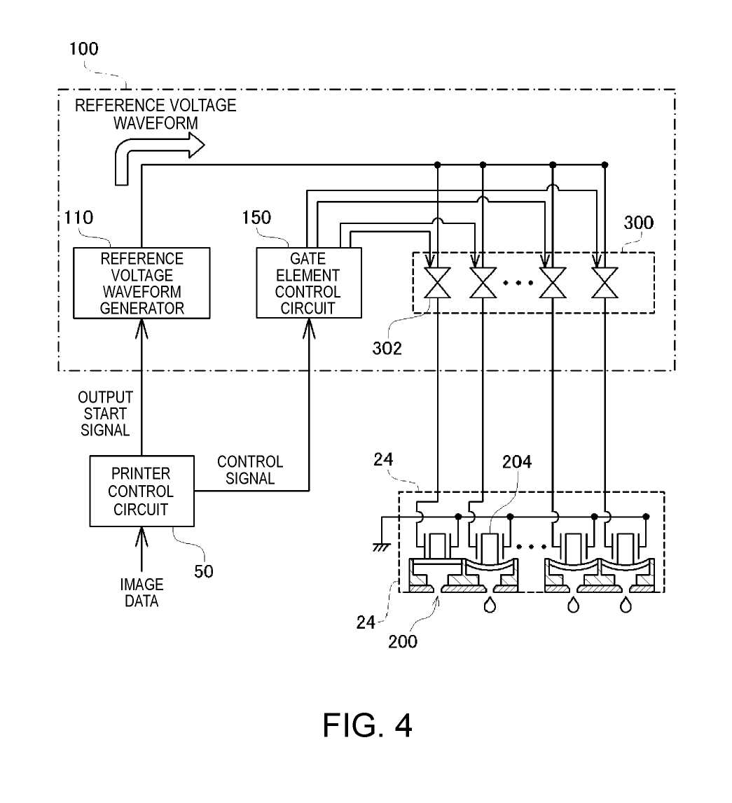

FIG. 4 is an explanatory diagram showing a circuit configuration of the piezoelectric element drive circuit 100 according to the present embodiment. The piezoelectric element drive circuit 100 according to the present embodiment is provided with a reference voltage waveform generator 110, a gate element control circuit 150, and a gate unit 300. Here, the reference voltage waveform denotes a voltage waveform with the voltage rising from a predetermined lower-limit voltage Vmin to a predetermined upper-limit voltage Vmax, and then dropping to the lower-limit voltage Vmin again. It should be noted that in the present embodiment, the lower-limit voltage Vmin corresponds to a “first voltage” according to the invention, and the upper-limit voltage Vmax corresponds to a “second voltage” according to the invention.

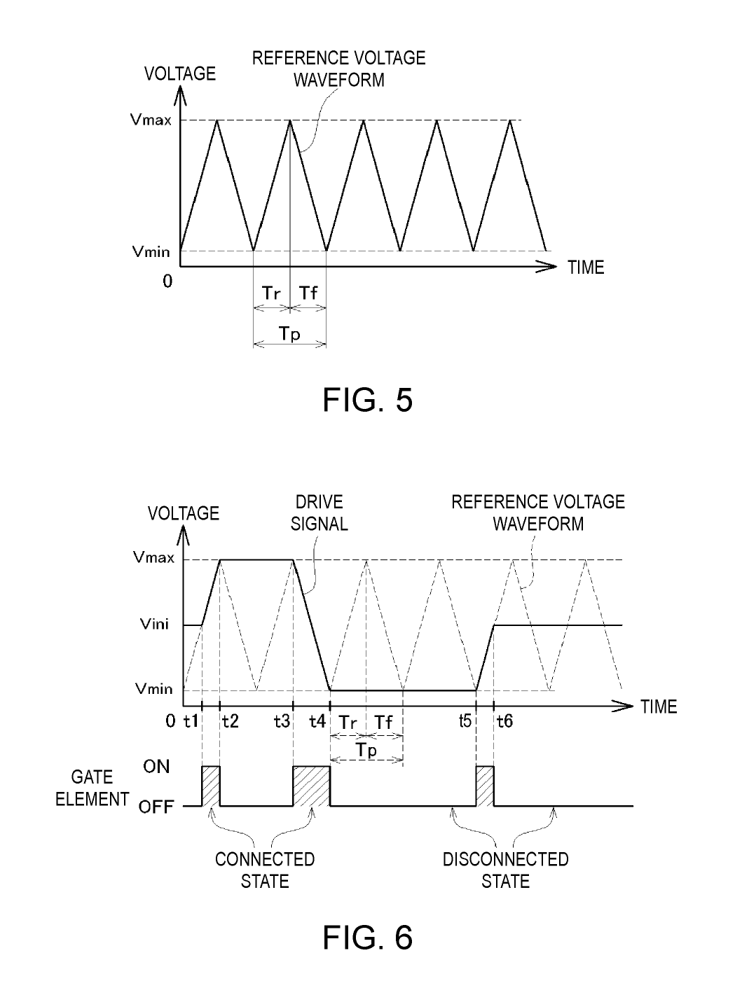

FIG. 5 shows the reference voltage waveform used in the piezoelectric element drive circuit 100 according to the present embodiment. FIG. 5 shows the state in which the voltage rises from the predetermined lower-limit voltage Vmin to the predetermined upper-limit voltage Vmax in a period corresponding to a rising period Tr, and then drops to the lower-limit voltage Vmin again in a period corresponding to a falling period Tf. However, the reference voltage waveform is not limited to such a waveform, but any voltage waveform can be used providing the waveform has the voltage monotonically rising from the lower-limit voltage Vmin to the upper-limit voltage Vmax, and then monotonically dropping from the upper-limit voltage Vmax to the lower-limit voltage Vmin. For example, a trapezoidal waveform with the voltage rising from the lower-limit voltage Vmin to the upper-limit voltage Vmax, and then keeping the upper-limit voltage Vmax for a while after reaching the upper-limit voltage Vmax, and a waveform, such as a sine wave, with the voltage varying at a low variation rate in the vicinity of the upper-limit voltage Vmax and the lower-limit voltage Vmin can preferably be used as the reference voltage waveform. The reference voltage waveform generator 110 outputs such a reference voltage waveform repeatedly at a predetermined repetition period Tp (Tp≧Tr+Tf). It should be noted that in the present embodiment the reference voltage waveform generator 110 corresponds to a “reference voltage waveform generation section” according to the invention.

Further, the gate unit 300 is composed of a plurality of gate elements 302. Each of the gate elements 302 is supplied with the reference voltage waveform from the reference voltage waveform generator 110, and the piezoelectric elements 204 are connected to the downstream side of the respective gate elements 302. The gate elements 302 can individually be switched between an electrically connected state and an electrically disconnected state. Further, the gate element control circuit 150 controls switching of each of the gate elements 302 between the connected state and the disconnected state. Therefore, the reference voltage waveform from the reference voltage waveform generator 110 is applied to the piezoelectric element 204 of the gate element controlled to be the connected state by the gate element control circuit 150 while passing through the gate element 302. Further, the reference voltage waveform from the reference voltage waveform generator 110 is never applied to the piezoelectric element 204 of the gate element 302 controlled to be the disconnected state. It should be noted that in the present embodiment, the gate element 302 corresponds to a “switch” according to the invention, and the gate element control circuit 150 corresponds to a “switch control section” according to the invention.

As shown in FIG. 4, in the piezoelectric element drive circuit 100 according to the present embodiment, when receiving an output start signal from the printer control circuit 50, the reference voltage waveform generator 110 starts to output the reference voltage waveform at a constant repetition period Tp. Further, when receiving the control signal from the printer control circuit 50 the gate element control circuit 150 determines the timing of setting the gate element 302 to the connected state or the disconnected state based on the control signal. It should be noted that since there is disposed a plurality of gate elements 302, the timing of switching between the connected state and the disconnected state is determined for each of the gate elements 302. Then, each of the gate elements 302 is switched to the connected state or the disconnected state in accordance with the content thus determined. According to the process described above, it becomes possible to apply the drive signal shown in FIG. 3 to the piezoelectric elements 204 connected to the respective gate elements 302. This point will hereinafter be explained in detail.

### C. Method of Applying Drive Signal

FIG. 6 is an explanatory diagram exemplifying how the drive signal is applied to the piezoelectric element 204 by switching a certain gate element 302 between the connected state (ON) and the disconnected state (OFF). In FIG. 6, the reference voltage waveform output from the reference voltage waveform generator 110 is indicated by the thin dashed lines, and the voltage applied to the piezoelectric element 204 is indicated by the heavy solid lines. Firstly, it is assumed that the voltage (the inter-terminal voltage of the piezoelectric element 204) applied to the piezoelectric element 204 as an initial state is an initial voltage Vini. Since the charge stored in the piezoelectric element 204 does not increase or decrease providing the gate element 302 is kept in the disconnected state, the voltage applied to the piezoelectric element 204 is kept in the initial voltage Vini.

Further, when the reference voltage waveform from the reference voltage waveform generator 110 rises from the lower-limit voltage Vmin and then reaches the initial voltage Vini, the gate element 302 is set to the connected state (ON). In FIG. 6, the voltage of the reference voltage waveform reaches the initial voltage Vini at the timing of the time t1, and therefore, the gate element 302 is switched ON. Then, the reference voltage waveform generator 110 and the piezoelectric element 204 get into the state of being electrically connected to each other. As a result, as indicated by the heavy solid lines in FIG. 6, the voltage to be applied to the piezoelectric element 204 rises along the reference voltage waveform.

Subsequently, the gate element 302 is set to the disconnected state (OFF) at the timing of the time t2. At this time, the voltage of the reference voltage waveform reaches the upper-limit voltage Vmax. When switching OFF the gate element 302, the reference voltage waveform generator 110 and the piezoelectric element 204 get into the state of being electrically disconnected from each other. Therefore, even when the voltage of the reference voltage waveform drops as indicated by the thin dashed lines in the drawing, the voltage to be applied to the piezoelectric element 204 is kept in the upper-limit voltage Vmax as indicated by the heavy solid lines in the drawing.

Subsequently, the gate element 302 is kept in OFF during the period in which the voltage of the reference voltage waveform drops to the lower-limit voltage Vmin, then shifts to rise, and then reaches the upper-limit voltage Vmax. Then, at the time t3, the voltage of the reference voltage waveform reaches the upper-limit voltage Vmax to be equal to the applied voltage of the piezoelectric element 204, and therefore, the gate element 302 is switched ON. Then, the reference voltage waveform generator 110 and the piezoelectric element 204 get into the state of being electrically connected to each other, and therefore, the voltage to be applied to the piezoelectric element 204 drops as the voltage of the reference voltage waveform drops as indicated by the heavy solid lines in FIG. 6.

Then, after switching OFF the gate element 302 at the timing of the time t4, the gate element 302 is switched ON again at the timing of the time t5. Here, as shown in FIG. 6, the voltage of the reference voltage waveform drops to the lower-limit voltage Vmin at the time t4, and after the time corresponding to two cycles (2Tp) of the repetition period Tp of the reference voltage waveform has elapsed, namely at the time t5, the voltage of the reference voltage waveform drops again to the lower-limit voltage Vmin. As a result, the voltage to be applied to the piezoelectric element 204 is kept at the lower-limit voltage Vmin of the reference voltage waveform during the period from the time t4 to the time t5, and then the applied voltage of the piezoelectric element 204 rises in accordance with the rise in the voltage of the reference voltage waveform on and after the time t5. Then, when the voltage of the reference voltage waveform reaches the initial voltage Vini (when the time t6 is reached), the gate element 302 is switched OFF. Then, the voltage to be applied to the piezoelectric element 204 thereafter gets into the state of being kept in the initial voltage Vini.

As explained hereinabove, by switching the gate element 302 to the connected state (ON) or the disconnected state (OFF) at an appropriate timing in sync with the reference voltage waveform output from the reference voltage waveform generator 110, it is possible to apply the drive signal to the piezoelectric element 204 as indicated by the heavy solid line in FIG. 6. Further, if it is assumed that the drive signal is applied using such a method, it is possible to generate a plurality of types of drive signals from a single type of reference voltage waveform and then apply them to the piezoelectric element 204 only by changing the timing of switching between ON/OFF of the gate element 302 as explained below.

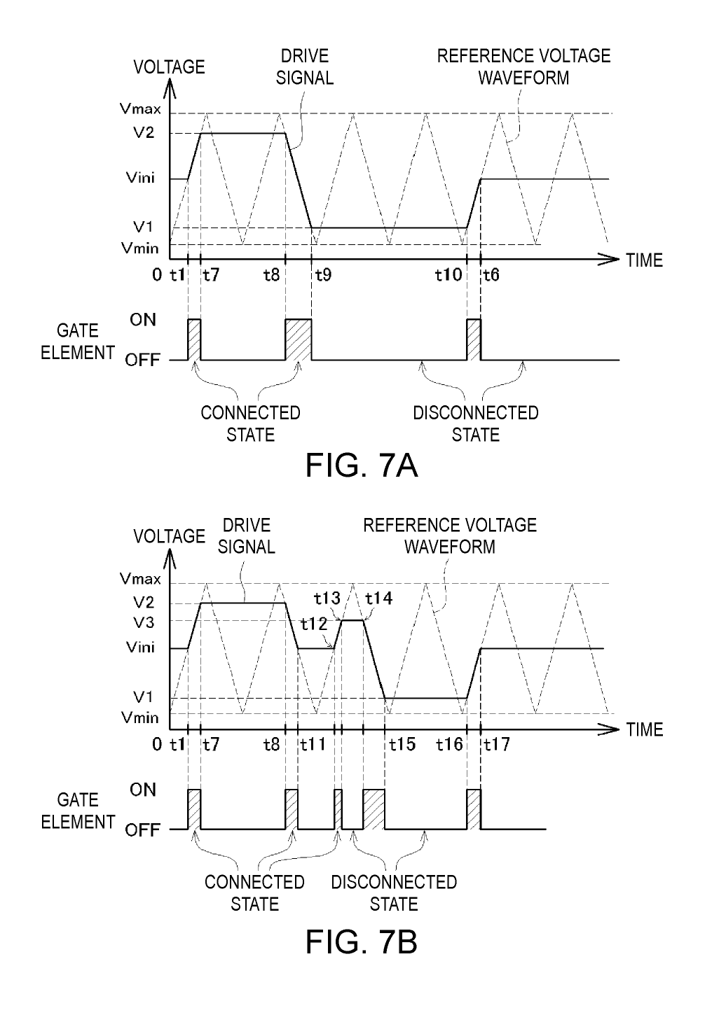

FIGS. 7A and 7B are explanatory diagrams exemplifying how the plurality of types of drive signals is generated by changing the timing of switching ON/OFF the gate element 302. For example, as exemplified in FIG. 7A, the gate element 302 is switched ON at the time t1, and is then switched OFF at the timing (the time t7) at which the voltage of the reference voltage waveform reaches a voltage V2 lower than the upper-limit voltage Vmax. Subsequently, the gate element is switched ON at the timing (the time t8) at which the voltage of the reference voltage waveform drops to the voltage V2 (the voltage when the gate element 302 is switched OFF) after the voltage of the reference voltage waveform reaches the upper-limit voltage Vmax, then drops to the lower-limit voltage Vmin, and then reaches the upper-limit voltage Vmax again. In other words, once the gate element 302 is switched OFF during the rise in the voltage of the reference voltage waveform, the voltage (here, the voltage V2) at that time is held for a period of time corresponding to the repetition period Tp of the reference voltage waveform, and then the gate element 302 is switched ON again at the timing (here, the time t8) at which the voltage of the reference voltage waveform drops to reach the voltage V2 the next time.

Then, once the gate element 302 is switched ON during the drop of the voltage of the reference voltage waveform, the gate element 302 is switched OFF at the timing (the time t9) at which the voltage of the reference voltage waveform reaches a voltage V1 higher than the lower-limit voltage Vmin. Subsequently, the gate element 302 is switched ON at the timing (the time t10) at which the voltage of the reference voltage waveform rises to the voltage V1 after the voltage of the reference voltage waveform drops to the lower-limit voltage Vmin, and then the time corresponding to two cycles (2Tp) of the repetition period Tp of the reference voltage waveform has elapsed. In other words, once the gate element 302 is switched OFF during the drop of the voltage of the reference voltage waveform, the voltage (here, the voltage V1) at that time is held for a period of time corresponding to two cycles (2Tp) of the repetition period Tp of the reference voltage waveform, and then the gate element 302 is switched ON again at the timing (here, the time t10) at which the voltage of the reference voltage waveform rises to reach the voltage V1 the next time. Then, thereafter the gate element 302 is switched OFF at the timing (the time t6) at which the voltage of the reference voltage waveform reaches the initial voltage Vini.

According to the process described above, there can be generated the drive signal with the voltage rising from the initial voltage Vini to the voltage V2, then kept in the voltage V2 for a while, then dropping from the voltage V2 to the voltage V1, then kept in the voltage V1 for a while, and then rising to the initial voltage Vini again as indicated by the heavy solid line in FIG. 7A. Obviously, by changing the timing (the time t7) of switching OFF the gate element 302 during the rise in the voltage of the reference voltage waveform, the value of the voltage V2 can be changed. It should be noted that in the case of changing the time t7, thereafter the timing (the time t8) of switching ON the gate element 302 is also changed accordingly. Similarly, by changing the timing (the time t9) of switching OFF the gate element 302 during the drop of the voltage of the reference voltage waveform, the value of the voltage V1 can be changed. It should be noted that in the case of changing the time t9, thereafter the timing (the time t10) of switching ON the gate element 302 is also changed.

If the timing of switching between ON/OFF of the gate element 302 is changed as described above, it becomes possible to apply the plurality of types of drive signals having the respective values of the highest voltage (V2) and the lowest voltage (V1) different from each other to the piezoelectric element 204 despite the fact that only the single type of reference voltage waveform is output from the reference voltage waveform generator 110. Therefore, in the example shown in, for example, FIG. 7A, since the highest voltage of the drive signal is lower, the suction amount of the ink to the ink chamber 202 is smaller, and further, since the lowest voltage of the drive signal is higher, the pushing amount of the ink from the ink chamber 202 becomes smaller compared to the case of applying the drive signal shown in FIG. 6 to the piezoelectric element 204. Therefore, by changing the drive signal to be applied to the piezoelectric element 204 from the drive signal shown in FIG. 6 to the drive signal shown in FIG. 7A, it becomes possible to reduce the amount of the ink ejected from the ejection nozzle 200.

Further, in the example described above, only the highest voltage (V2) of the drive signal or the lowest voltage (V1) thereof is made different, and the basic shape (i.e., the shape of the wave with the voltage rising from the initial voltage Vini to the highest voltage, then dropping to the lowest voltage, and then returning to the initial voltage Vini) of the waveform does not change. However, it is also possible to apply a drive signal different in the basic shape of the waveform.

For example, as exemplified in FIG. 7B, the gate element 302 is switched ON at the time t1, and is then switched OFF at the timing (the time t7) at which the voltage of the reference voltage waveform reaches the voltage V2. Then, after holding the OFF state for a period equal to or longer than the repetition period Tp of the reference voltage waveform, the gate element 302 is switched ON at the timing (the time t8) at which the voltage of the reference voltage waveform drops to the voltage V2 during the drop of the voltage of the reference voltage waveform. However, as shown in FIG. 7B, the gate element 302 is switched OFF at the timing (the time t11) at which the voltage of the reference voltage waveform reaches the initial voltage Vini, and then the gate element 302 is switched ON at the timing (the time t12) at which the voltage of the reference voltage waveform once having dropped to the lower-limit voltage Vmin rises to the initial voltage Vini. Then, the gate element 302 is switched OFF at the timing (the time t13) at which the voltage of the reference voltage waveform on the rise reaches a voltage V3 lower than the voltage V2, and then the gate element 302 is switched ON at the timing (the time t14) at which the voltage of the reference voltage waveform once having risen to the upper-limit voltage Vmax drops to the voltage V3. In other words, in the drop of the voltage of the reference voltage waveform, once the gate element 302 is switched OFF at the timing at which the voltage reaches the initial voltage Vini, the gate element 302 is switched ON at the timing at which the voltage of the reference voltage waveform once having dropped to the lower-limit voltage Vmin rises to the initial voltage Vini. Further, in the rise in the voltage of the reference voltage waveform, once the gate element 302 is switched OFF at the timing at which the voltage reaches the voltage V3, the gate element 302 is switched ON at the timing at which the voltage of the reference voltage waveform once having risen to the upper-limit voltage Vmax drops to the voltage V3.

Subsequently, the gate element 302 is switched OFF at the timing (the time t15) at which the voltage of the reference voltage waveform on the drop reaches the voltage V1 higher than the lower-limit voltage Vmin. Then, after keeping the OFF state of the gate element 302 for a period corresponding to the repetition period Tp of the reference voltage waveform, the gate element 302 is switched ON at the timing (the time t16) at which the voltage of the reference voltage waveform once having dropped to the lower-limit voltage Vmin rises to the voltage V1. Then, thereafter the gate element 302 is switched OFF at the timing (the time t17) at which the voltage of the reference voltage waveform reaches the initial voltage Vini.

According to the process described above, there can be generated the drive signal with the voltage rising from the initial voltage Vini to the voltage V2, then kept in the voltage V2 for a while, then dropping from the voltage V2 to the initial voltage Vini, then rising to the voltage V3 at once, then dropping to the voltage V1, then kept in the voltage V1 for a while, and then rising to the initial voltage Vini again as indicated by the heavy solid line in FIG. 7B.

By applying such a drive signal to the piezoelectric element 204, it becomes possible to eject smaller amount of ink compared to the case of simply changing the highest voltage V2 and the lowest voltage V1 as described with reference to FIG. 7A. This point will be explained below with reference to the drive signal shown in FIG. 7B. Firstly, by the voltage of the drive signal rising (increasing the capacity of the ink chamber 202) to the voltage V2, the ink is sucked into the ink chamber 202. Subsequently, although the ink starts to be pushed out from the ejection nozzle 200 of the ink chamber 202 by the voltage of the drive signal dropping (reducing the capacity of the ink chamber 202), the drop of the voltage of the drive signal stops at the time point at which the voltage drops to the initial voltage Vini, and then the voltage of the drive signal rises a little bit (increasing the capacity of the ink chamber 202 a little bit). Therefore, the ink having started to be pushed from the ejection nozzle 200 due to the reduction in capacity of the ink chamber 202 gets into the state in which the ink is torn off in the middle thereof by starting to increase the capacity of the ink chamber 202, and thus the small amount of ink is ejected from the ejection nozzle 200. Subsequently, although the voltage of the drive signal drops (reducing the capacity of the ink chamber 202) again, no ink is elected due to the voltage drop in the drive signal because some of the ink in the ink chamber 202 has already been ejected. Therefore, it is possible to eject smaller amount of ink compared to the case of simply lowering the highest voltage V2 of the drive signal or raising the lowest voltage V1 using the method shown in FIG. 7A. It should be noted that, as is obvious from the above explanation, the voltage level at which the voltage of the drive signal is held in the middle after dropping the voltage from the voltage V2 is only required to be the voltage level which the ink can be torn off by thereafter raising the voltage from, and is not necessarily limited to the initial voltage Vini.

Further, by making the basic shapes of the respective drive signals different from each other, the ejection conditions (e.g., an amount of the ink) of the ink can more flexibly be changed. Further, according to the method of the present embodiment, it is possible to change the highest voltage (V2) and the lowest voltage (V1) of the drive signal, or to change the basic shape of the waveform of the drive signal only by changing the timing of switching between ON/OFF of the gate element 302 while outputting a single type of reference voltage waveform. Therefore, since it is not required to previously store the plurality of types of drive signals as having been performed in the past, it is not required to install the storage capacity therefor to the piezoelectric element drive circuit 100.

In addition, according to the method of the present embodiment, a great advantage as described below can be obtained. Specifically, the reference voltage waveform generator 110 only outputs the single type of reference voltage waveform, and the drive signal is applied to the piezoelectric element 204 by switching between ON/OFF of the gate element 302 disposed between the reference voltage waveform generator 110 and the piezoelectric element 204. Further, the drive signal to be applied to the piezoelectric element 204 can be changed due to the timing of switching between ON/OFF of the gate element 302. Therefore, by switching ON/OFF a certain gate element 302 and another gate element 302 adjacent thereto out of the plurality of gate elements 302 shown in FIG. 4 at respective timings different from each other, it is possible to apply the drive signals different from each other to the piezoelectric elements 204 adjacent to each other. It is possible to, for example, apply the drive signal shown in FIG. 6 to one of the piezoelectric elements 204, and the drive signal shown in FIG. 7A to the other of the piezoelectric element 204.

Further, since the drive signals different from each other can be applied at the same timing as described above, it becomes possible to raise the drive frequency of the piezoelectric element 204. Specifically, in the existing method, a plurality of types of drive signals is supplied in series to the gate elements 302 (and the piezoelectric elements 204) and the gate elements 302 are switched between ON/OFF to select either of the drive signals to thereby apply the drive signal thus selected to the piezoelectric element 204. However, according to such a method, in the case of attempting to apply a certain type of drive signal again to the piezoelectric element 204 to which the same drive signal has been applied, there is no choice other than to wait until output of a different type of drive signal is terminated. In contrast, according to the method of the present embodiment, since the drive signals different from each other can be applied to the respective piezoelectric elements 204 at the same timing, it becomes possible to raise the drive frequency of each of the piezoelectric elements 204. Further, according to the method of the present embodiment, even in the case in which the number of types of the drive signal increases, the drive frequency never drops due to the increase.

Furthermore, according to the method of the present embodiment, since the drive signals different from each other can be applied to the respective piezoelectric elements 204 at the same timing, it becomes also possible to correct the variation between the ejection nozzles 200 and the variation between the piezoelectric elements 204. Specifically, since the manufacturing variation exists in the ejection nozzles 200 or the piezoelectric elements 204, there exist the ejection nozzles 200 through which a larger amount of ink than average is ejected and the ejection nozzles 200 through which a smaller amount of ink than average is ejected. Therefore, regarding the ejection nozzles 200 through which the larger amount of ink than average is ejected, the timing of switching between ON/OFF of the gate element 302 is corrected so that the highest voltage (V2) of the drive signal is lowered, or the lowest voltage (V1) of the drive signal is raised. Further, regarding the ejection nozzles 200 through which the smaller amount of ink than average is ejected, the timing of switching between ON/OFF of the gate element 302 is corrected so that the highest voltage (V2) of the drive signal is raised, or the lowest voltage (V1) of the drive signal is lowered. According to the process described above, it becomes possible to easily correct any variation in the ejection amount due to the manufacturing variation existing between the ejection nozzles 200.

### D. MODIFIED EXAMPLES

There exist several modified examples in the present embodiment described above. Hereinafter, these modified examples will briefly be explained. It should be noted that in the modified examples described below, the explanation will be presented focusing on the difference from the present embodiment described above, and the constituents not particularly mentioned are substantially the same as those of the present embodiment described above. Further, it is assumed that the constituents substantially the same as those of the present embodiment will be denoted by the same reference numerals in the modified examples, and the explanation therefor will be omitted.

### D-1. First Modified Example

In the example described above, the explanation is presented assuming that the ink is ejected from the ejection nozzle 200 by applying the drive signal to the piezoelectric element 204. However, according to the method of the present embodiment, since the drive signal can flexibly be changed in accordance with the timing of switching ON/OFF of the gate element 302, it is also possible to apply the drive signal with which the ink is not ejected from the nozzle 200.

FIG. 8 is an explanatory diagram exemplifying the drive signal to be applied to the piezoelectric element 204 in a first modified example. In the example shown in the drawing, the gate element 302 is switched ON at the timing (the time t1) at which the voltage of the reference voltage waveform rises to the initial voltage Vini, and then the gate element 302 is switched OFF at the timing (the time t18) at which the voltage rises a little bit to reach the voltage V4. Then, after keeping the state for a period corresponding to two cycles of the repetition period Tp of the reference voltage waveform, the gate element is switched ON at the timing (the time t20) at which the voltage of the reference voltage waveform dropping from the upper-limit voltage Vmax reaches a voltage V4, and then the gate element 302 is switched OFF again when the voltage of the reference voltage waveform drops to the initial voltage Vini. According to the process described above, as indicated by the heavy solid lines in FIG. 8, the drive signal with the voltage rising from the initial voltage Vini to the voltage V4, then kept in the voltage V4 for a while, and then dropping to the initial voltage Vini again can be applied to the piezoelectric element 204. Then, when such a drive signal is applied, the capacity of the ink chamber 202 increases a little bit due to the voltage rising from the initial voltage Vini to the voltage V4. However, since the increased amount is small, only the ink around the ejection nozzle 200 is just pulled into the ink chamber 202 instead of newly sucking the ink from the ink cartridge 26 into the ink chamber 202. Subsequently, when the voltage of the drive signal drops from the voltage V4 to the initial voltage Vini, the capacity of the ink chamber 202 is also reduced to the original capacity. Since the decreased amount of the capacity at this time is also small, only the ink having been pulled in the ink chamber 202 just returns to the vicinity of the ejection nozzle 200 instead of being ejected from the ejection nozzle 200.

Then, as shown in FIG. 8, by repeatedly applying such a drive signal to the piezoelectric element 204, it is possible to repeat to pull the ink around the ejection nozzle 200 into the ink chamber 202 and to return the ink to the vicinity of the ejection nozzle 200 from the inside of the ink chamber 202. As a result, since the ink around the ejection nozzle 200 is agitated, it can be avoided that the ink in the ejection nozzle 200 is transformed due to evaporation of the moisture of the ink or volatilization of the volatile component thereof. It becomes possible to realize the application of such a drive signal only by controlling the timing of switching ON/OFF of the gate element 302.

### D-2. Second Modified Example

Further, in the embodiment described above, the reference voltage waveform is repeatedly output at the repetition period Tp, and the drive signal is applied by switching ON/OFF of the gate element 302 at appropriate timings while the reference voltage waveform is output for a plurality of cycles. Therefore, by shifting the timing of switching ON/OFF of the gate element 302 by one cycle of the reference voltage waveform, the timing of ejecting the ink from the ejection nozzle 200 can also be shifted.

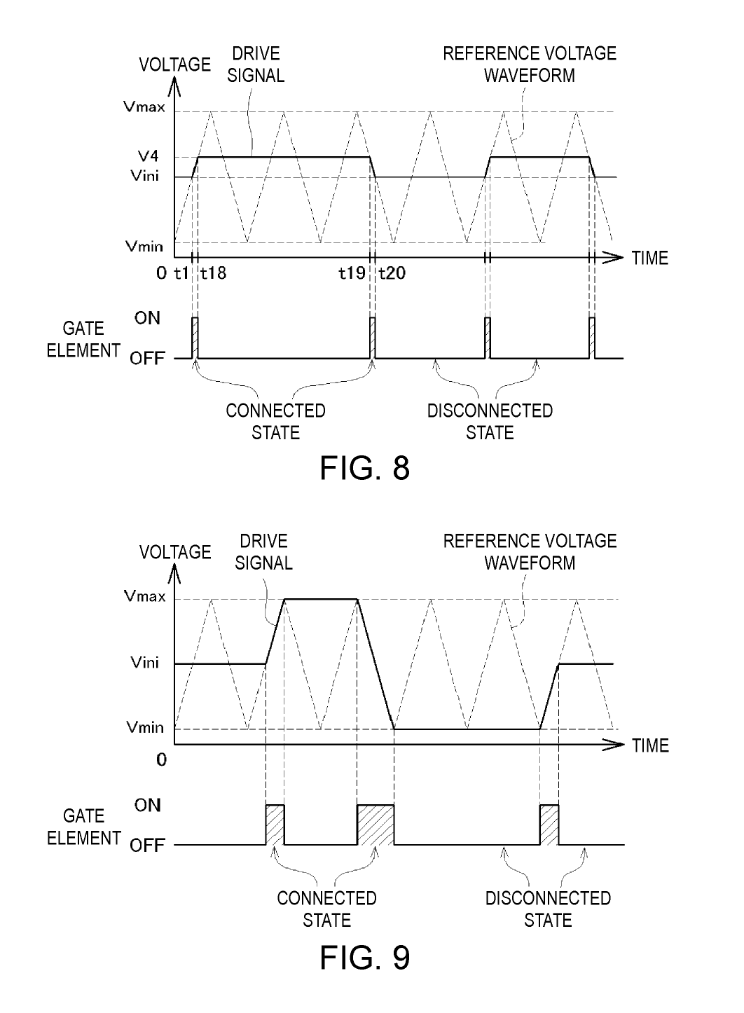

FIG. 9 is an explanatory diagram exemplifying how the timing of ejecting the ink from the ejection nozzle 200 is shifted in a second modified example. Although the drive signal shown in FIG. 9 is the same as the drive signal described above using FIG. 6, in the example shown in FIG. 9, the drive signal is delayed by one cycle of the reference voltage waveform compared to the case shown in FIG. 6. It is obvious that the drive signal can be applied at the timing delayed by a plurality of cycles. Further, it is also possible to apply the drive signal at the timing by one cycle or a plurality of cycles of the reference voltage waveform earlier. Therefore, it becomes also possible for a desired election nozzle 200 out of the plural ejection nozzles 200 to eject the ink at a timing different from that of the other ejection nozzles 200.

### D-3. Third Modified Example

Further, in the embodiment or the modified examples described above, the explanation is presented assuming that there is used the reference voltage waveform shown in FIG. 5, namely the waveform with the voltage linearly rising from the lower-limit voltage Vmin to the upper-limit voltage Vmax in a period (Tr≈0.5Tp) roughly a half of the repetition period Tp, and then linearly dropping from the upper-limit voltage Vmax to the lower-limit voltage Vmin in the remaining repetition period, namely a period (Tf≈0.5Tp) roughly a half of the repetition period Tp. However, the reference voltage waveform is not limited to such a waveform, but a variety of waveforms can be used as the reference voltage waveform.

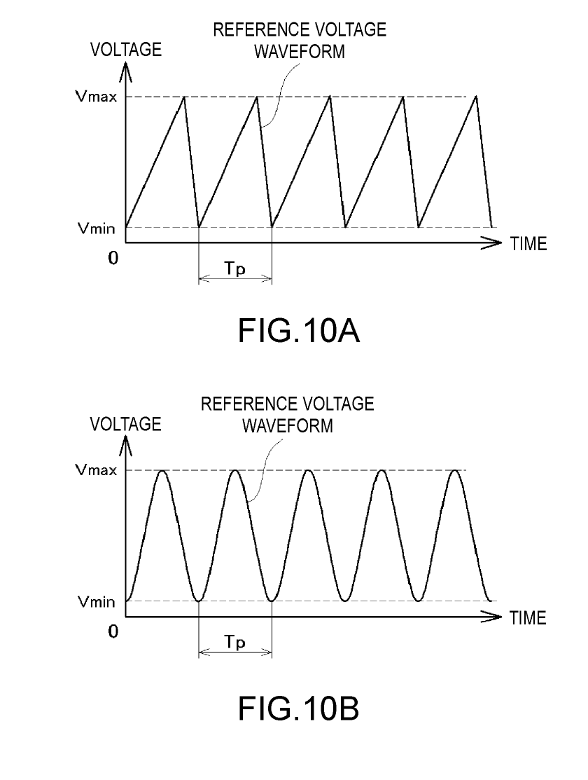

FIGS. 10A and 10B are explanatory diagrams exemplifying a variety of reference voltage waveforms. For example, in the reference voltage waveform shown in FIG. 10A, the voltage slowly rises from the lower-limit voltage Vmin to the upper-limit voltage Vmax taking time (Tr>0.5Tp) longer than a half of the repetition period Tp, and then rapidly drops from the upper-limit voltage Vmax to the lower-limit voltage Vmin in a period (Tf<0.5Tp) shorter then a half of the repetition period Tp. By using such a reference voltage waveform, the capacity of the ink chamber 202 slowly increases in an increase process. Therefore, it is possible to calmly suck the ink from the ink cartridge 26 into the ink chamber 202 without substantially moving the ink around the ejection nozzle 200. The capacity of the ink chamber 202 rapidly decreases in a decrease process. Therefore, it becomes possible to eject the ink from the ejection nozzle 200 at a high speed.

Further, as shown in FIG. 10B, a sine wave or a waveform with the voltage slowly varying in the vicinities of the upper-limit voltage Vmax and the lower-limit voltage Vmin can be used as the reference voltage waveform. Compared to the triangular waveform shown in FIGS. 5 and 10A, the waveform (in particular the sine wave) with the voltage slowly varying in the vicinities of the upper-limit voltage Vmax and the lower-limit voltage Vmin can easily be generated. Therefore, according to the third modified example, it becomes possible to realize the reference voltage waveform generator 110 with a simple structure.

### D-4. Fourth Modified Example

In the embodiment and the modified examples described above, the explanation is presented assuming that it is sufficient for the repetition period Tp of the reference voltage waveform to be a period sufficiently shorter than the drive signal. Specifically, the explanation is presented assuming that it is sufficient for the repetition period Tp of the reference voltage waveform to be sufficiently short to the extent that the desired drive signal can be obtained because the drive signal is applied by switching ON/OFF the gate element 302 at appropriate timings during a period in which a plurality of cycles of the reference voltage waveform is output.

However, as described above, when the drive signal is applied to the piezoelectric element 204, the capacity of the ink chamber 202 increases or decreases, and the ink in the ink chamber 202 is ejected from the ejection nozzle 200 when the capacity decreases. Further, the structure composed of the ink chamber 202 and the ejection nozzles 200 provided to the ink chamber 202 and filled with the ink in the inside thereof has a characteristic vibration period Tc determined by the capacity of the ink chamber 202, the aperture area of the ejection nozzle 200, and the physicality (e.g., the viscosity and the specific gravity) of the ink. Taking the relationship with the characteristic vibration period into consideration, it is preferable to set the repetition period Tp to the following period.

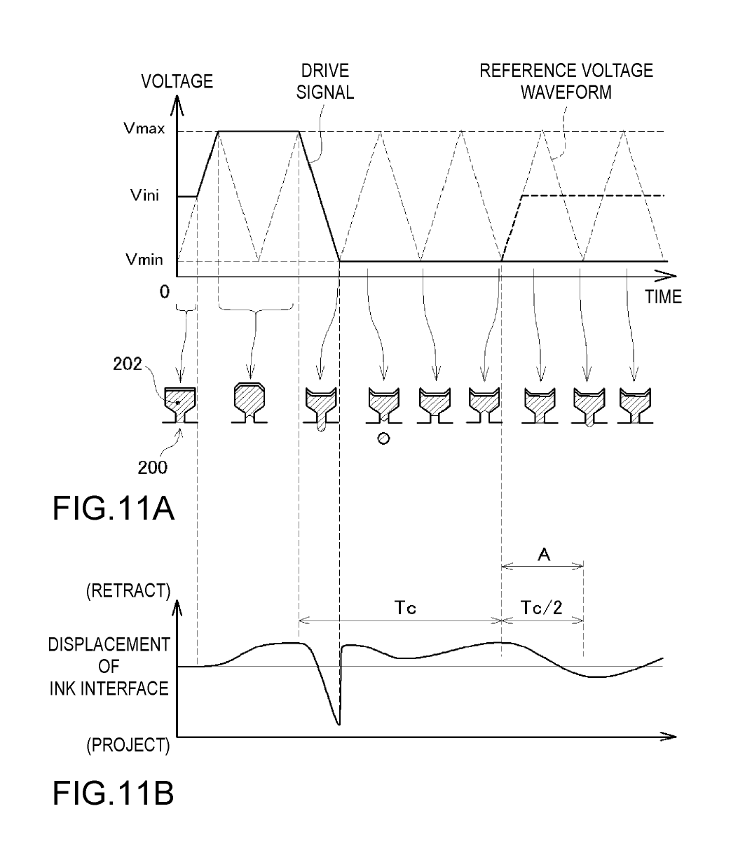

FIGS. 11A and 11B are explanatory diagrams showing what movement the surface of the ink in the vicinity of the ejection nozzle 200 makes in the case in which the ink is ejected from the ejection nozzle 200, and then the capacity of the ink chamber 202 is kept in the state immediately after the ejection. FIG. 11A schematically shows the reference voltage waveform (the dashed lines) with the repetition period Tp (the rising period Tr, the falling period Tf), the drive signal (the heavy solid lines) to be applied to the piezoelectric element 204, the capacity variation of the ink chamber 202 due to the expansion and contraction of the piezoelectric element 204, and the movement of the ink in the vicinity of the ejection nozzle 200. Further, FIG. 11B shows the displacement of the ink interface in the vicinity of the ejection nozzle 200.

As shown in the drawings, in the initial state in which the voltage of the drive signal is the initial voltage Vini, the ink chamber 202 is not deformed, and is kept in the state in which the ejection nozzle 200 is filled with the ink to the near tip portion thereof. Subsequently, when the voltage of the drive signal is raised (to the upper-limit voltage Vmax in FIG. 11A), the piezoelectric element 204 contracts to thereby increase the capacity of the ink chamber 202. As a result, the ink interface located near to the tip of the ejection nozzle 200 is temporarily pulled toward the ink chamber 202.

Subsequently, when the voltage of the drive signal is dropped straight (to the lower-limit voltage Vmin in the example shown in FIG. 11A) to a voltage lower than the initial voltage Vini, the ink in the ink chamber 202 is pushed out at once and ejected from the ejection nozzle 200. FIG. 11A schematically shows the process in which the ink in the ink chamber 202 is pushed out from the ejection nozzle 200 and ejected as a droplet when the voltage of the drive signal drops straight from the upper-limit voltage Vmax to the lower-limit voltage Vmin.

When the ink is ejected from the ejection nozzle 200, the position of the ink interface retracts in accordance with the amount of the ink ejected. However, since the ink remaining in the ink chamber 202 also moves toward the ejection nozzle 200 due to the inertia, the ink interface is urged to move forward from the retracted position toward the exit side of the ejection nozzle 200. Here, as shown in FIG. 11A, if the voltage of the drive signal is kept in the value (the lower-limit voltage Vmin in FIG. 11A) immediately after the ejection of the ink, the flow of the ink toward the exit side of the ejection nozzle 200 immediately after the ejection goes down with time, and then the ink is urged to flow in a direction of returning to the ink chamber 202 due to the back action thereof. Although the flow of the ink urged to return into the ink chamber 202 becomes gradually stronger, after the flow stops in due course, the ink starts to flow again toward the exit side of the ejection nozzle 200. As described above, when keeping the state after completion of the ink ejection, the flow toward the exit side of the ejection nozzle 200 and the flow urged to return into the ink chamber 202 are generated alternately, and the period thereof corresponds to the characteristic vibration period Tc of the ink chamber 202. FIG. 11B shows how the position of the ink interface varies around the ejection nozzle 200 in accordance with such a movement of the ink.

Although such a vibration of the ink interface is gradually attenuated as time goes on, if the drive signal is applied to the piezoelectric element 204 in the state in which the vibration of the ink interface still remains, the movement of the ink interface due to the expansion and contraction of the piezoelectric element 204 is disturbed due to the influence of the residual vibration of the ink interface, and therefore, it becomes unachievable to normally eject the ink. Therefore, it is desirable for the vibration of the ink interface occurring after the ink ejection to be attenuated as soon as possible. Further, in order to attenuate the vibration of the ink interface, it is sufficient to increase (raise the voltage of the drive signal) the capacity of the ink chamber 202 when the ink in the ink chamber 202 is urged to flow toward the exit of the ejection nozzle 200. According to this process, since the flow of the ink toward the exit of the ejection nozzle 200 is canceled out with the force for pulling the ink back due to the increase in capacity of the ink chamber 202, it is possible to promptly attenuate the vibration of the ink interface.

In FIG. 11B, some period from when the retracting movement of the ink interface of the ejection nozzle 200 is changed to the reverse after the ink interface is significantly retracted due to the ink ejection (denoted with “A” in the drawing, specifically, a period a half as long as the characteristic period Tc) corresponds to the period in which the flow toward the exit of the ejection nozzle 200 occurs in the ink contained in the ink chamber 202. Therefore, it is sufficient to return the voltage of the drive signal, which has been dropped to the lowest voltage in order to eject the ink (here, the lower-limit voltage Vmin), to the initial voltage Vini within the period denoted with “A” in the drawing after the period corresponding to the characteristic vibration period Tc has elapsed from the timing (here, the time t3 (see FIG. 6)) of starting to drop the voltage from the highest voltage (here, the upper-limit voltage Vmax). Further, in order to achieve this, as shown in FIG. 11B, it is sufficient to set the repetition period Tp and the falling period Tf of the reference voltage waveform within the range fulfilling Formula 1 below with respect to the characteristic vibration period Tc of the ink chamber 202.

Tc≦n·Tp+Tf≦1.5Tc (1)

Here, n denotes a natural number, and is set to n=2 in the example shown in FIGS. 11A and 11B. According to the above settings, since it is possible to return the voltage of the drive signal to the initial voltage Vini in the period during which the ink in the ink chamber 202 is urged to flow toward the exit of the ejection nozzle 200 after the ink ejection, it becomes possible to promptly attenuate the vibration of the ink interface.

It should be noted that, in order to more effectively attenuate the vibration of the ink interface, it is sufficient to increase (raise the voltage of the drive signal) the capacity of the ink chamber 202 within the period (a former half of the period “A” in the drawing) during which the ink in the ink chamber 202 is accelerated to start to flow toward the exit of the ejection nozzle 200. Therefore, it is sufficient to set the repetition period Tp of the reference voltage waveform to the period represented by Formula 2 below with respect to the characteristic vibration period Tc of the ink chamber 202.

Tc≦n·Tp+Tf≦1.5Tc (2)

According to the above settings, since it is possible to return the voltage of the drive signal to the initial voltage Vini in the period during which the ink in the ink chamber 202 is accelerated to start to flow toward the exit of the ejection nozzle 200 after the ink ejection, it becomes possible to more promptly attenuate the vibration of the ink interface.

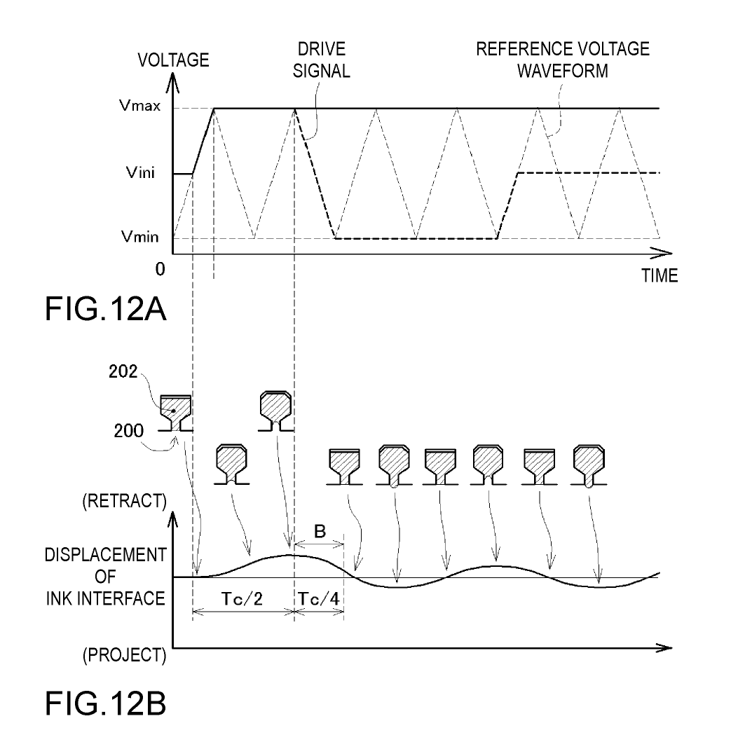

Further, in order to increase the speed of the ink ejected using the vibration of the ink interface described above, it is desirable to set the repetition period Tp to the following period. FIGS. 12A and 12B are explanatory diagrams showing what movement the interface of the ink in the vicinity of the ejection nozzle 200 makes in the case in which the voltage of the drive signal is raised from the initial voltage Vini, and then the capacity of the ink chamber 202 is kept in the state without change. FIG. 12A schematically shows the reference voltage waveform (the dashed lines) with the repetition period Tp (the rising period Tr, the falling period Tf), the drive signal (the heavy solid lines) to be applied to the piezoelectric element 204, the capacity variation of the ink chamber 202 due to the expansion and contraction of the piezoelectric element 204, and the movement of the ink in the vicinity of the ejection nozzle 200. Further, FIG. 12B shows the displacement of the ink interface in the vicinity of the ejection nozzle 200.

As described above, when the voltage of the drive signal is raised (to the upper-limit voltage Vmax in FIG. 12A) in the initial state in which the voltage of the drive signal is the initial voltage Vini, the piezoelectric element 204 contracts to thereby increase the capacity of the ink chamber 202. As a result, although the ink interface having been located near to the tip of the ejection nozzle 200 is pulled in temporarily toward the ink chamber 202, after the movement stops in due course, the ink interface starts to return toward the original position (the vicinity of the tip of the ejection nozzle 200). On this occasion, since the ink in the ink chamber 202 is accelerated to start to flow toward the exit of the ejection nozzle 200, by reducing (dropping the voltage of the drive signal) the capacity of the ink chamber 200 taking advantage of the acceleration, the ink in the ink chamber 202 is further accelerated and ejected from the ejection nozzle 200.

In FIG. 12B, some period from when the retracting movement of the ink interface of the ejection nozzle 200 is changed to the reverse after the voltage of the drive signal is raised in the initial state in which the voltage of the drive signal is the initial voltage Vini to thereby significantly retract the ink interface (denoted with “B” in the drawing, specifically, a period corresponding to a fourth of the characteristic period Tc) corresponds to the period in which the ink in the ink chamber 202 is accelerated to start to flow toward the exit of the ejection nozzle 200. Therefore, it is sufficient to start to drop the voltage of the drive signal within the period of “B” in the drawing after the period (0.5Tc) a half as long as the characteristic vibration period Tc has elapsed from the timing (here, the time t1 (see FIG. 6)) of starting to raise the voltage of the drive signal in the initial state in which the voltage of the drive signal is the initial voltage Vini. Further, in order to achieve this, as shown in FIG. 12B, it is sufficient to set the repetition period Tp and the rising period Tr of the reference voltage waveform at least within the range expressed by Formula 3 below with respect to the characteristic vibration period Tc of the ink chamber 202.

0.5Tc≦m·Tp+Tr≦0.75Tc (3)

Here, m denotes a natural number, and is set to m=1 in FIGS. 12A and 12B. According to the above settings, since it is possible to drop the voltage of the drive signal in the period during which the flow of the ink is accelerated to start to flow toward the exit of the ejection nozzle 200, it becomes possible to increase the speed of the ink to be ejected.

It should be noted that taking the requirement (Tr≧0.5Tp) explained in the embodiment or the modified examples described above into consideration, it is desirable that the repetition period Tp of the reference voltage waveform is at least equal to or shorter than a half of the characteristic vibration period Tc of the ink chamber 202. In addition, by setting n in Formula 1 to a value equal to or greater than 2, it becomes possible to efficiently achieve both of the increase in the speed of the ink to be ejected and the attenuation of the vibration of the ink interface.

### D-5. Fifth Modified Example

Further, in the embodiment or the modified examples described above, the explanation is presented assuming that the piezoelectric element drive circuit 100 drives the piezoelectric element 204 mounted on the ejection head 24 of the inkjet printer 10. However, the piezoelectric element drive circuit 100 can preferably be applied not only to the piezoelectric element 204 of the ejection head 24, but also to the case of, for example, driving the piezoelectric element installed in a fluid ejection device other than the inkjet printer 10 as an actuator.

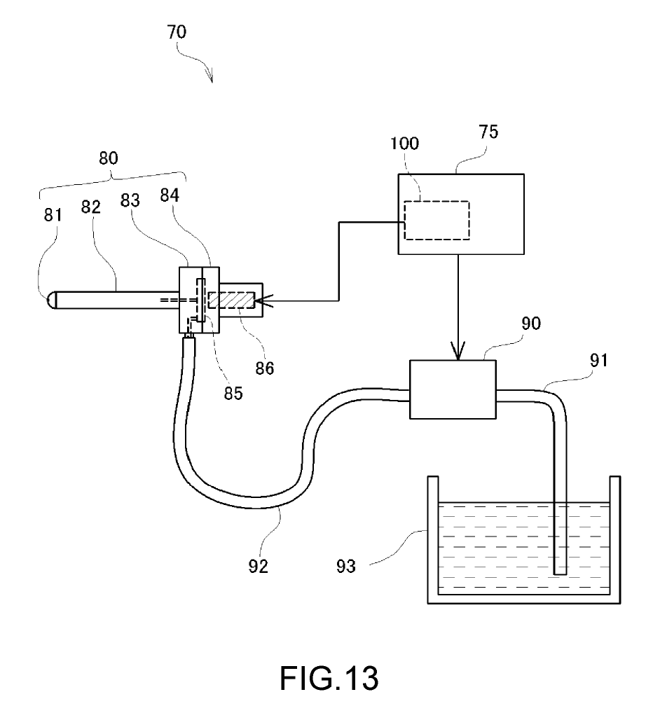

FIG. 13 is an explanatory diagram exemplifying a fluid ejection device 70 for ejecting a liquid using the piezoelectric element. The fluid ejection device 70 thus exemplified is composed of an ejection unit 80 for ejecting the fluid in a pulsed manner, a fluid supply section 90 for supplying the fluid to be ejected from the ejection unit 80 toward the ejection unit 80, a control unit 75 for controlling the operations of the ejection unit 80 and the fluid supply section 90, and so on in the general classification.

The ejection unit 80 has a structure of stacking a first case 84 made of metal on a second case 83 also made of metal, wherein a fluid ejection tube 82 shaped like a circular tube is erected on the front surface of the second case 83, and a nozzle 81 is inserted on the tip of the fluid ejection tube 82. In the boundary face between the second case 83 and the first case 84, there is disposed a fluid chamber 85 shaped like a thin disc, and the fluid chamber 85 is connected to the nozzle 81 via the fluid ejection tube 82. Further, inside the first case 84, there is disposed a piezoelectric element 86 as an actuator so as to make it possible to deform the fluid chamber 85 by driving the piezoelectric element 86 to thereby vary the capacity of the fluid chamber 85.

The fluid supply section 90 sucks up the fluid (e.g., water, saline, or chemical) from a fluid container 93 reserving the fluid to be ejected via a first connection tube 91, and then supplies it into the fluid chamber 85 of the ejection unit 80 via a second connection tube 92. The operation of the fluid supply section 90 is controlled by the control unit 75. Further, the control unit 75 incorporates the piezoelectric element drive circuit 100, and ejects the fluid in a pulsed manner from the nozzle 81 of the ejection unit 80 by the piezoelectric element drive circuit 100 supplying the drive signal generated to thereby drive the piezoelectric element 86.

In also such a fluid ejection device 70, by making the drive signal applied to the piezoelectric element 86 different, the ejection conditions of the fluid can be made different. Further, by generating the drive signal using the method of the present embodiment or the modified examples described above, the drive signal to be applied to the piezoelectric element 86 can be changed without having stored the plurality of types of drive signals. Therefore, the control unit 75 is not required to prepare a large amount of storage capacity for storing the plurality of drive signals. In addition, since the highest voltage or the lowest voltage of the drive signal can finely be varied by changing the timings of switching ON/OFF of the gate element 302 provided to the piezoelectric element drive circuit 100, it becomes possible to finely correct the difference in the ejection characteristics due to the manufacturing variation and the temporal change in the ejection unit 80 to thereby maintain the stable ejection characteristics.

Although the various types of the piezoelectric element drive circuit 100 are hereinabove explained, the invention is not limited to each of the embodiment and the modified examples described above, but can be put into practice in various forms within the scope or the spirit of the invention. The piezoelectric element drive circuit 100 can preferably be applied to a circuit for driving a piezoelectric element for driving a variety of electronic equipment such as a fluid ejection device used for forming microcapsules including a medical agent of a nutritional supplement, or medical equipment using a fluid ejection device.

This application claims priority to Japanese Patent Application No. 2011-091798, filed on Apr. 18, 2011, the entirety of which is hereby incorporated by reference.

What is claimed is:

1. A fluid ejection device adapted to deform a fluid chamber using a piezoelectric element to thereby eject a fluid in the fluid chamber, comprising:
a reference voltage waveform generator adapted to generate a reference voltage waveform, which has a voltage increasing from a first voltage to a second voltage higher than the first voltage, and then decreasing from the second voltage to the first voltage, at a predetermined repetition period;
a switch disposed between the reference voltage waveform generator and the piezoelectric element, and adapted to switch between a connected state in which the reference voltage waveform generator and the piezoelectric element are electrically connected to each other and a disconnected state in which the reference voltage waveform generator and the piezoelectric element are electrically disconnected from each other; and
a switch control section adapted to switch the switch between the connected state and the disconnected state in accordance with increase and decrease of the voltage of the reference voltage waveform to thereby apply a drive signal to the piezoelectric element,
wherein the repetition period is one of equal to and shorter than a half of a characteristic vibration period of the fluid chamber.

2. The fluid ejection device according to claim 1, wherein
the fluid ejection device is provided with a plurality of the piezoelectric elements,
the switch is provided to each of the piezoelectric elements, and
the switch control section individually switch each of the switches between the connected state and the disconnected state.

3. A medical instrument comprising the fluid ejection device according to claim 1.

4. A medical instrument comprising the fluid ejection device according to claim 2.
